(19) United States
(12) Patent Application Publication
(10) Pub. No.: US 2013/0290459 A1
(43) Pub. Date: Oct. 31, 2013

(54) Configurable Escalation Queue

(71) Applicants: Michael Cuff, Clyde Hill, WA (US); Chih Wang, Bothell, WA (US); Farhad Kasad, Bothell, WA (US); Firdaus Aryana, Seattle, WA (US); Gordon J. Hines, Kirkland, WA (US)

(72) Inventors: Michael Cuff, Clyde Hill, WA (US); Chih Wang, Bothell, WA (US); Farhad Kasad, Bothell, WA (US); Firdaus Aryana, Seattle, WA (US); Gordon J. Hines, Kirkland, WA (US)

(21) Appl. No.: 13/847,245

(22) Filed: Mar. 19, 2013

Related U.S. Application Data
(60) Provisional application No. 61/615,576, filed on Mar. 26, 2012.

(51) Int. Cl. H04L 12/58

(52) U.S. Cl. CPC H04L 51/26
USPC 709/207

(57) ABSTRACT

A rapid assignment dynamic ownership queue for text message sessions queues incoming text messages destined for a service bureau, at a network server. Simultaneous access is provided to any one text message of the queued incoming text messages to a plurality of operator terminals at the service bureau. Initial ownership of the one text message is assigned as a result of a first acting terminal of the plurality of operator terminals having completed an action in service to the text message, and ownership is re-assigned to a subsequent operator terminal having completed another action in service to the text message after the first acting terminal. A configurable escalation queue may be implemented to assign an escalation code to each queued item, regardless of its position in the queue list, to alter the presentation of the queue item.

The present invention claims priority from U.S. Provisional No. 61/615,567 entitled “Rapid Assignment Dynamic Ownership Queue” to Cuff et al., filed Mar. 26, 2012; U.S. Provisional No. 61/615,576 entitled “Configurable Escalation Queue” to Cuff et al., filed Mar. 26, 2012; and U.S. Provisional No. 61/615,580 entitled “No Responders Online” to Cuff et al., filed Mar. 26, 2012, the entirety of all of which are expressly incorporated herein by reference.

### BACKGROUND OF THE INVENTION

1. Field of the Invention

This invention relates generally to emergency messaging. More particularly, it relates to queue mechanisms and queue control for systems that have multiple users capable of doing work for any given item inserted into the queue mechanism.

2. Background of Related Art

9-1-1 is a phone number widely recognized in North America as an emergency phone number that is used to contact emergency dispatch personnel. Enhanced 9-1-1 (E9-1-1) is defined by an emergency call being selectively routed to an appropriate PSAP, based on a special identifier (P-ANI, or “Pseudo Automatic Number Identifier”, also referred to as “ESxK”), and includes the transmission of callback number and location information when 9-1-1 is used. E9-1-1 may be implemented for landline, cellular or VoIP networks. A Public Service Answering Point (PSAP) is a dispatch office that receives 9-1-1 calls from the public. A PSAP may be a local, fire or police department, an ambulance service or a regional office covering all services. As used herein, the term “PSAP” refers to either a public safety access point (PSAP), or to an Emergency Call Center (ECC), a VoIP term.

The current 911 infrastructure is designed to route a live voice call to a local public safety answering point (PSAP), with location data typically staged in a database that is queried by the PSAP to determine location information. More recently the possibility of text messaging an emergency message to ‘911’ has become a reality. But the handling of emergency text messages by a public safety answering point is in its infancy, with much to be improved upon.

For instance, existing queue mechanisms for assigning responsibility to handle an incoming emergency text message is believed by the present inventors to be too slow and too inflexible. The lack of speed and flexibility comes from the use of a conventional queuing mechanism to handle incoming emergency text messages, which the current inventors have appreciated adds overhead to transactions made from the queue, costing time. Conventionally a first-available PSAP operator is given responsibility for an incoming emergency text message, and handles disposition of the needs of that emergency texter. Once assigned to that PSAP operator, re-assignment of responsibility for that given item (e.g., emergency text message) taken from the queue mechanism is not possible, unless the emergency text is returned to the queue.

The present inventors appreciate that such conventional assignment from an incoming emergency text message queue proves to be a terrible disadvantage in that it does not permit the same queue item (e.g., a given emergency text message) to be taken and worked on by a different recipient device (e.g., another PSAP operator) that may excel at certain needs of the queue item more than others, at various times in its life cycle. If reassignment of a given queued item (e.g., an emergency text message) is enabled, it is conventionally not as fast as the inventors herein feel it could be for the same reason that initial assignment is not fast: the re-assignment of any given transaction taken from the queuing mechanism (e.g., a given emergency text message) must be completed first, before a new ‘owner’ device can take that same queued item and perform work for it.

### SUMMARY OF THE INVENTION

In accordance with the principles of the present invention, a configurable escalation queue-sorting of a text message session comprises queuing incoming text messages destined for a service bureau, at a network server. An escalation value is assigned to each incoming text message in an incoming text message queue, each escalation value having a type, a threshold, and a level associated therewith. The queued incoming text messages are occasionally resorted both in order of a first in/first out queue and in order according to escalation code assigned to each queued incoming text message.

In another aspect of the invention of a configurable escalation queue queuing text message sessions with a service bureau, the configurable escalation queue comprises a queue item database table. Each queued item in the queue item database table includes an escalation code associated therewith. The configurable escalation queue also includes an escalation code database table. The queued items in the queue item database table are occasionally resorted within the queued item database table based on an evaluation of the escalation code associated with each queued item.

### BRIEF DESCRIPTION OF THE DRAWINGS

Features and advantages of the present invention will become apparent to those skilled in the art from the following description with reference to the drawings, in which:

FIG. 1 shows a short message service (SMS) 9-1-1 system including rapid assignment queuing, in accordance with the principles of the present invention.

FIG. 2 shows a database table structure for the rapid assignment dynamic ownership queue, in accordance with the principles of the present invention.

FIG. 3 shows a database table structure for an exemplary configurable escalation queue, in accordance with the principles of the present invention.

FIG. 4 shows a no responders online (NRO) Application_User table, in accordance with the principles of the present invention.

### DETAILED DESCRIPTION OF ILLUSTRATIVE EMBODIMENTS

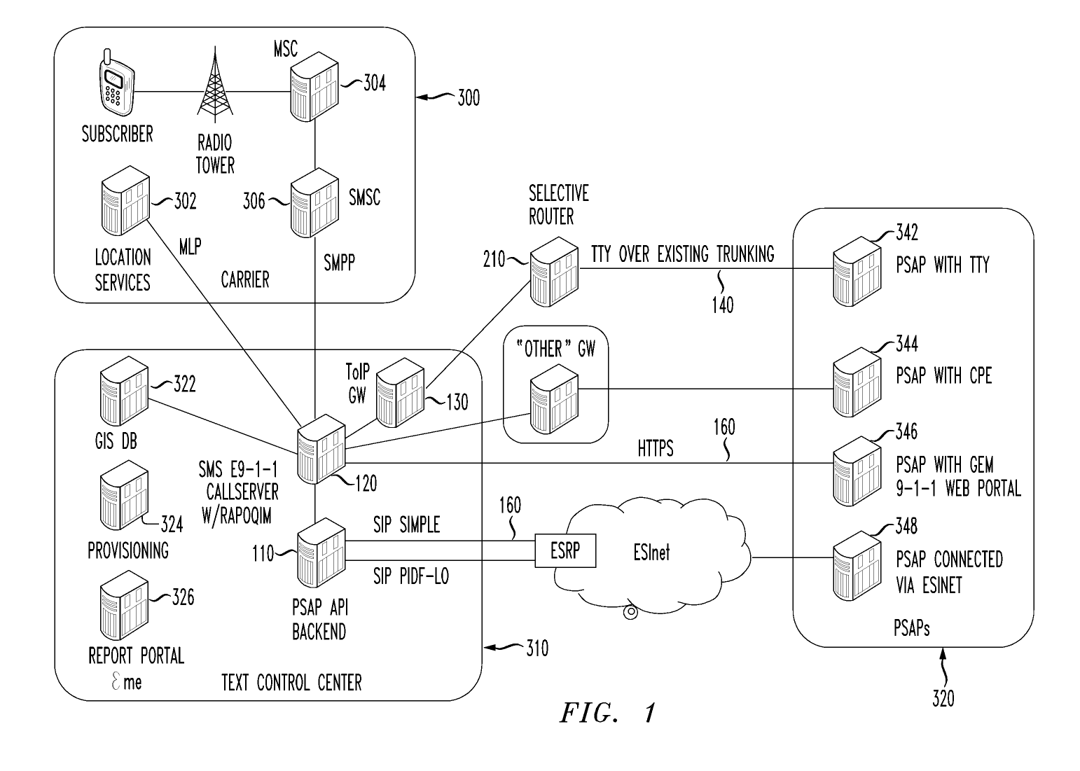

FIG. 1 shows a text message service (e.g., short message system (SMS)) 9-1-1 system including rapid assignment queuing, in accordance with the principles of the present invention.

As shown in FIG. 1, an emergency text message service system 310 communicates with a given carrier 300 from which a given emergency text messaging device is provided service, and a network of public safety answering points (PSAPs) 320.

The relevant devices within the carrier network 300 include location services gateways 302, a mobile switching center (MSC) 304, a short message service center (SMSC) 306, and a radio tower(s) 308 that communicate directly with a given subscriber wireless device 309 attempting to submit an emergency text message.

The emergency text message service system (aka emergency text control center) 310 includes a text message call server 120 that communicates with the SMSC 306 and location services 302 of the carrier 300. The text message call server 120 also communicates with a global information system (GIS) database, a provisioning device 324, and a reporting portal 326. The text message call server 120 also communicates with a PSAP API backend 110, and a ToIP gateway 130.

The emergency text message service system 310 is a scalable standards-compliant service that supports automatic call routing and delivery of SMS messages to the public safety answering point (PSAP) nearest to a given wireless SMS texter's location. The PSAP call taker sees the wireless SMS device's relevant information, including location information, displayed in the same way that the call taker does for a wireless call dependent on the interface solution that is utilized by the PSAP. The SMS 9-1-1 system is preferably interoperable with Next Generation 9-1-1 networks.

There are four options for a PSAP to interconnect with the emergency text message service system 310: SMS to teletype (TTY) conversion; Direct integration with customer premises equipment (CPE) e.g., NENA i3); PSAP SMS opt out; and/or SMS using a geospatial emergency management (GEM) 9-1-1 client (web browser). Thus, the PSAPs 320 are serviced by the emergency text message service system 310 via multiple different services: a PSAP with TTY 342, a PSAP with CPE 344, a PSAP with geospatial emergency management (GEM) 9-1-1 web portal 346, and a PSAP connected via ESInet 348.

The emergency text message service system 310 automatically call routes a text message to the appropriate PSAP, based on the coarse location of the endpoint. The emergency text message service system 310 delivers the text messages to the appropriate PSAP over the appropriate interface 342, 344, 346 or 348. The emergency text message service system 310 provides a session-like experience for the PSAP operators interacting with the person who is texting. The emergency text message service system 310 supports PSAP requests for updated location information, reports portal for the carrier, and supports automatic bounce-back message.

The emergency text message service system 310 system comprises a geospatial emergency manager (GEM) 9-1-1 backend 110, a teletype (TTY) gateway 130, and an SMS 9-1-1 call server 120.

The geospatial emergency manager (GEM) 9-1-1 backend 110 delivers the content for a geospatial emergency manager (GEM) client application.

The teletype (TTY) gateway 130 receives text messages (e.g., SMS text messages) and converts to teletype (TTY)/Baudot traffic to be sent to the peering network provider for routing to the appropriate PSAP who have selected TTY as their interface type.

The SMS 9-1-1 call server 120 determines the initial handling of a new SMS conversation and maintains and manages the ongoing text sessions (session management). The SMS 9-1-1 call server 120 is a core element of the emergency text message service system 310.

Interfaces provided to a supported PSAP include a teletype (TTY) legacy interface 140, a geospatial emergency manager (GEM) 9-1-1 over HTTPs interface 150, and a Direct IP over SIP SIMPLE interface 160.

The TTY legacy interface 140 utilizes an existing E9-1-1 call path through a selective router 210 and over existing trunking 140 to the PSAP's customer premises equipment (CPE). The TTY legacy apparatus relies on utilization of access to the appropriate selective router 210 for delivery to the appropriate PSAP. The selection of the access to the appropriate selective router 210 must be pre-determined in agreement with the carrier network 300. PSAPs that select the TTY legacy apparatus utilize an automatic location identification (ALI) link to obtain initial location and updated location. Due to the nature of legacy 5-bit Baudot/TTY, not all ASCII characters that can be entered via SMS can be displayed via Baudot/TTY. For example, @ # * % & < > § are not supported in Baudot/TTY. Additional characters are often not supported dependent on the individual PSAPs TTY implementation/customer premises equipment (CPE).

The geospatial emergency manager (GEM) 9-1-1 over HTTPs interface 150 provides a full feature service enabling PSAP personnel to interact with the public.

The Direct IP over SIP SIMPLE interface 160 provides a full feature service that is directly integrated into a PSAPs infrastructure. The supported PSAPs have access to a web-based HTTPs administration interface for managing GEM 9-1-1 service credentials and policy routing functions/deny lists for both GEM 9-1-1 and TTY services.

Thus, the SMS 9-1-1 service in accordance with the present invention provides location determination, call routing, automatic bounce-back message, and session management, as well as an administration tool.

The location determination of the emergency text message service system 310 automatically requests location via a connection to the carrier's location platform for the purpose of receiving coarse location for initial call routing and precise/best effort for updated location. A call operator at the PSAP is given the ability to request updated location information from their selected interface.

The emergency text message service system 310 automatically call routes an SMS text message to the appropriate PSAP 320, based on the coarse location of the endpoint.

An automatic bounce-back message is provided. The emergency text message service system 310 automatically sends a carrier-dictated standardized message to a subscriber in the cases where there is an attempt to send an SMS text message to 911, and, e.g.,: (1) There are no serving PSAPs in the calling wireless device's determined location; (2) The serving PSAP is off-line from the service; (3) The serving PSAP has the calling wireless device's MDN (or other unique identification) in a deny list; (4) The serving PSAP has triggered a session limit; (5) The serving PSAP has triggered a time-of-day rule; or (6) The carrier's location platform did not return a valid location for the subscriber.

The emergency text message service system 310 includes session management for SMS text messages sent to the PSAP to provide a session-like experience for the PSAP 320. The PSAP 320 is given the control to end the session its determination.

A web based administration tool is provided with the emergency text message service system 310. The web based administration tool communicates over the HTTP connection 150 to the PSAP 320 for the following exemplary administrative functions:

(a) Creating GEM 9-1-1 credentials—Creates credentials for users to log into the GEM 9-1-1 service.

(b) Resetting GEM 9-1-1 credentials—Allows for the administrator to reset the password for GEM 9-1-1 user accounts.

(c) Status of GEM 9-1-1 users—Allows for the administrator to view the Logged In status of GEM 9-1-1 users and account status of GEM 9-1-1 users.

(d) Inputting Deny List Entries—Allows for the administrator to input an MDN of a wireless subscriber to always get an automatic bounce back message for all SMS to 9-1-1 attempts for that specific PSAP when that wireless subscriber is call routed to that PSAP.

(e) Quick Message Pre-defined Responses—Allows for the administrator to configure pre-defined canned GEM 9-1-1 responses and sort in a specified order for the pre-defined Quick Messages that show within the GEM 9-1-1 service for that specific PSAP for all GEM 9-1-1 users of that specific PSAP.

(f) Alternate PSAP List—Allows for the administrator to set a list of alternate PSAPs for the primary PSAP to fall back to for new SMS sessions if the primary PSAP has a time-of-day or session limit policy routing function rule that has been triggered. Each PSAP in the alternative PSAP list will be evaluated for their respective online status, policy routing functions and deny list entries and treated accordingly.

(g) Time-of-Day policy routing function rule—Allows for the administrator to set a time of day policy for a window of time where the PSAP will not receive any new SMS sessions. A new SMS session's attempt to the PSAP with the time-of-day policy routing function triggered will result in either an automatic bounce back message being sent back to the wireless subscriber, or the new SMS session routed to a PSAP listed in an alternate PSAP list.

(h) Session Limit policy routing function rule—Enables the administrator to set an SMS session limit for the PSAP. New SMS session attempts to the PSAP over the established SMS session limit will thus trigger the SMS session limit policy routing function. This results in an automatic bounce back message sent back to the wireless subscriber, or the new SMS session that is over the session limit will be sent to the PSAP listed in the alternative PSAP list.

The session management feature of the emergency text message service system 310 includes a novel emergency text message queue within the text message call server 120 that enables multiple users to self-assign or self-re-assign queue items (e.g., incoming emergency text messages) instantly, simply, and intuitively, by simply performing the work they desire to do against the target queued emergency text message, without first having to perform, or waiting for an administrator to perform, separate and preliminary ownership transactions. This emergency text message self-assigning queue, more broadly referred to herein as a rapid assignment dynamic ownership queue, is also given the acronym “RADOQIM” to stand for Rapid Assignment Dynamic Ownership Queue Item Mechanism (RADOQIM).

The rapid assignment dynamic ownership queue eliminates wasteful time and overhead that are conventionally required to first assign items (e.g., emergency text messages) to an application user device (e.g., a text-message-capable PSAP operator), in separate and preliminary ownership transactions, before the PSAP operator can perform any work. Simply put, conventional user devices (e.g., PSAP terminals 342-348) have to wait for ownership, or, perform ownership transactions themselves, before real work on the emergency text message can be accomplished. The PSAP terminals are not able to execute the real transactions against their target queue item (emergency text message) until after the ownership of that emergency text message is taken care of.

The rapid assignment dynamic ownership queue also eliminates wasteful time and overhead that are typically required to first re-assign an emergency text message to a PSAP operator terminal, in separate and preliminary ownership transactions, before the PSAP operator, in this case, the new owner of the queued emergency text message, can perform their job. Simply put, conventional re-assignment of queued items (emergency text messages) requires waiting for the ownership transfer to complete before a new PSAP operator can execute on that same emergency text message or emergency text message session. And that would be if that conventional emergency text message queue would allow re-assignment of an emergency text message. If reassignment is not allowed then even more time and overheard are wasted. The assigned emergency text message is essentially destroyed or archived and a new queued emergency text message is created for the new PSAP operator.

The emergency text message service system 310, commercially available from TeleCommunication Systems, Inc. of Annapolis, Md. called GEM911, handles queue item assignment (e.g., emergency text message session assignment) and ownership. GEM911 implements a rapid assignment dynamic ownership queue in a PSAP operator terminal via, e.g., a web application for handling 911 related text messages sent from mobile devices. Implementation of the GEM911 web application was achieved using specific software technologies such as Ruby on Rails and SQLLite, but is not limited in implementation to any particular technology. The inventive methods and apparatus explained herein may be implemented in any software technologies to achieve the most flexible, rapid, and dynamic queue item ownership mechanism possible. Similarly, the content or purpose of any rapid assignment dynamic ownership queue system is not limited to use in 911 emergency or Public Safety Answering Points, but rather may be used in other multiple user environments regardless of the nature or content of the queued items.

The rapid assignment dynamic ownership queue is unique because it makes work on queued items the dog, and assignment of the queued items the tail, instead of the other way around. Conventionally, assignment of a queued item happens first and work happens thereafter. The rapid assignment dynamic ownership queue enables the work to happen first and the assignment instantly updates as a result of the work. Zero time, zero overhead.

The “rapid assignment” aspect of the rapid assignment dynamic ownership queue refers to zero time required for assignment. The assignment is instant, thus zero overhead. The assignment process is gone. Preliminary ownership transactions are not required. The queue item is assigned to the user device (e.g., PSAP station) that successfully completed work against it. When a user device (e.g., PSAP station) wants a queue item the user does what they know needs to be done. For example, in the GEM911 application, the user device responds to a given emergency text message. No more waiting for the item to be assigned to a given PSAP operator station. You want it? Work on it! By virtue of successfully completing work, the queue item will belong to that PSAP station. Start work now and the assignment will follow in a blink.

The “dynamic ownership” aspect of the rapid assignment dynamic ownership queue means that just like with initial assignment, the user device that wants it, works on it, regardless of the message or message session's previous ownership. The re-assignment is achieved instantly, and notification is given to the previous owner device (e.g., PSAP station), by virtue of the work that was completed against the queue item by the new owner device. Just like in initial assignment. In the case of GEM911, a second PSAP operator responds to an emergency text message, even though a different, that is, first, PSAP operator already sent a response earlier. The queue item is instantly reassigned to the second PSAP operator with no overhead transactions related to ownership.

There is no “taking” or “assigning” of queue items with the rapid assignment dynamic ownership queue. Only working. To take a queue item, the PSAP station must complete work on it. A user device can select a queue item, but until a work transaction has been successfully completed and committed against the target queued item (or session), that user device has done nothing but look at the queue item.

Any application user device can perform work on any target queue item. The “owner” is simply the last user device (e.g., PSAP station) to have completed work against the queue item.

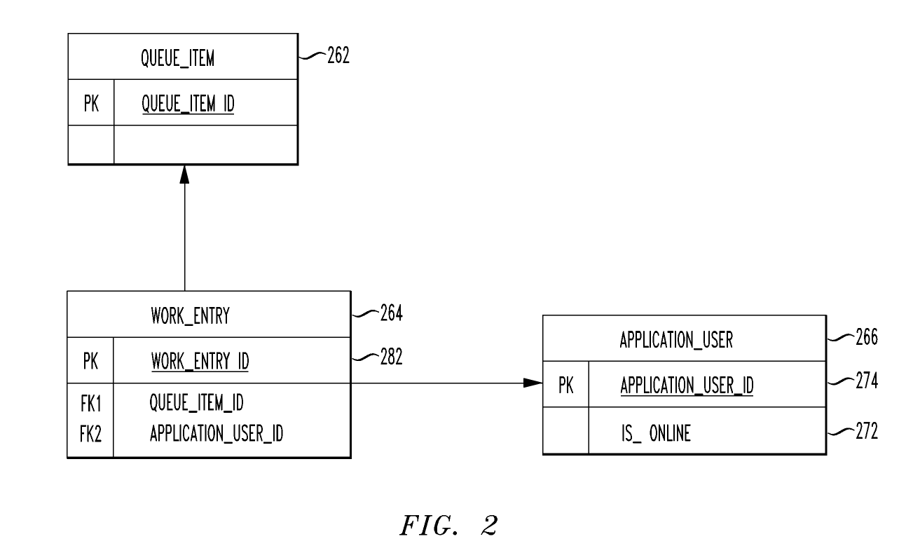

FIG. 2 shows a database table structure for the exemplary rapid assignment dynamic ownership queue, in accordance with the principles of the present invention.

Exemplary embodiments of a rapid assignment dynamic ownership queue in accordance with the principles of the present invention uses three (3) relational database tables as shown in FIG. 2. Any database technology can be used to create these tables. Any server application or other network device may implement a rapid assignment dynamic ownership queue with renamed database tables as best fits the specific domain space.

Queue_Item 262 is the first table (keeping in mind that the specific table names used herein are generic for the purposes of this disclosure.) The Queue_Item table can have any table name, and as many or as little fields as needed, to support the specific requirements of the given rapid assignment dynamic ownership queue. The Queue_Item 262 must be a parent table, having zero to many child records, to the child Work_Entry table.

Work_Entry 264 is the second database table. The rapid assignment dynamic ownership queue enables the Work_Entry table to have as much flexibility as possible, including the table name itself and the field definition. The only requirement for the rapid assignment dynamic ownership queue is that the Work_Entry 264 must have a required foreign key to the parent Queue_Item table.

The third and final table required by the rapid assignment dynamic ownership queue is an Application_User table. The Application_User 266 is also a parent to the Work_Entry table, also having zero to many child records. The Work_Entry table is required to have a foreign key to Application_User 266 and Queue_Item 262. The Application_User table, in addition to a field needed for its relationship to Work_Entry 264, must have at least one Boolean field. The purpose of this Boolean field is to track if the Application_User 266 is currently logged into the system.

Each Work_Entry record 264 has one and only one reference to Queue_Item parent record 262. Each Work_Entry record 264 also has one and only one reference to Application_User parent record 266.

Each Queue_Item record 262 has zero to many Work_Entry child records 264.

Each Application_User 266 has zero to many Work_Entry child records 264. Each Application_User record 266 also updates the Boolean field Is_Online 272 to true when the user logs into the system and false when the user logs out.

All Primary Keys are numeric, sequential ascending assignment when issuing values.

The content of these tables 262-266 enables a simple database query and categorization of the returning result set, placing each Queue_Item 262 into one of three categories.

There are three critical rapid assignment dynamic ownership queue categories: UNASSIGNED, ASSIGNED TO ME, and ASSIGNED TO OTHERS, in accordance with the principles of the present invention.

An UNASSIGNED queue item is a Queue_Item 262 that has no child Work_Entry record 264—OR—the last Work_Entry child record 264 has foreign key to Application_User record 266 where Is_Online 272=false. The rapid assignment dynamic ownership queue defines “Unassigned” as those Queue_Item records 262 which have no subordinate Work_Entry records 264 what so ever, or, where the last (latest entered, highest Work_Entry_ID 282 value) Work_Entry record 264 was entered by an Application_User 266 not currently online. In other words, where Is_Online 272 is false.

An ASSIGNED TO ME queue item is when a Last Work_Entry record for the Queue_Item 262 maps to Application_User 266 equal to the current user. Is_Online 272=true. The rapid assignment dynamic ownership queue defines “Assigned to Me” as those Queue_Item records 262 where the most recent, that is last, Work_Entry child record 264, was entered by the current user. The current user viewing the queue is obviously online.

An ASSIGNED TO OTHERS queue item is when a Last Work_Entry record for the Queue_Item 262 maps to Application_User 266 that has Is_Online 272=true and the Application_User 266 is not the current user. The rapid assignment dynamic ownership queue defines “Assigned to Others” as Queue_Item records 262 where the most recent, that is last, Work_Entry child record 264, was entered by an Application_User 266 currently online (Is_Online=true) and different from the current user.

Reassignment is as simple as entering more Work_Entry records 264 with a different Application_User ID 274. The Application_User 266 that successfully created and committed the latest Work_Entry record 264 is the new owner of the parent Queue_Item 262 for which that Work_Entry record 264 belongs.

Un-assignment happens when an Application_User 266 logs off the system. The update to the Application_User 266 record, specifically the Is_Online 272 Boolean being set to false, then causes the Queue_Item records 262 for which the recently logged off user had the last Work_Entry record 264, to be categorized as “Unassigned.” The record of that user's Work_Entry 264 is still intact, but because they were the owner, because they were the user for the last Work_Entry record 264, and now they are off line, the Queue_Item 262 becomes unassigned.

Race Conditions do not matter to the rapid assignment dynamic ownership queue. It is always as simple as choosing the last Work_Entry record 264 for a given Queue_Item 262. There is no limit to the number of Work_Entry records 264 that can be entered against a Queue_Item 262. No matter how close together two Work_Entry records 264 were created, one of them will come after the other. The user belonging to the last Work_Entry 264 is the owner of the parent Queue_Item 262.

As a specific example, the GEM911™ product developed by the inventors uses specific table names for the E911 domain space. The below example helps to illustrate how the generic model detailed above can be applied to almost any web application that benefits from instant and flexible assignment of queue items in a multi user environment.
Conversation (Queue_Item 262)
Response Messages (Work_Entry 264)
PSAP Operators (Application User 266)

Once a Queue_Item 262 is properly identified into one of the three rapid assignment dynamic ownership queue categories, the Queue_Item 262 can be displayed in whatever way best fits the application. For example, the GEM911 product displays three separate sections for the “Unassigned”, “Assigned to Me”, and “Assigned to Others” categories. The last two “Assigned” categories display the user name of the current owner, in addition to the core Queue_Item 262 content, in the case of GEM911, the phone numbers that texted 911 for help. The “Unassigned” section displays an empty string (“”). This is only one example of communicating the three categories and the Queue_Items 262 contained therein. Any means of separation and notification are easy to achieve in any kind of graphical user interface (GUI). Condition branches are simply used based on the rapid assignment dynamic ownership queue categorization of the queue items.

The rapid assignment dynamic ownership queue system is highly generic and broadly applicable to any domain space and application content, including processes that use queue items in a multi user environment.

The emergency text message service system 310 may preferably be comprised in a geo-redundant world-class data center in a 24×7×365 hosted environment. The data center may preferably be implemented with redundancy within a site, and geographically diverse. In this way during maintenance windows, only one side need be upgraded or changed and brought back into service, and full functionality confirmed, prior to upgrading/changing the other geo-redundant side.

A rapid assignment dynamic ownership queue in accordance with the present invention allows multiple users to self-assign or self-re-assign queue items instantly, simply, and intuitively, by simply performing the work they desire to do against the target queue item, without first having to perform, or waiting for an administrator to perform, separate and preliminary ownership transactions.

### Configurable Escalation Emergency Text Queuing

A problem with queues appreciated by the present inventors is that they are fundamentally relative. In a single column vertical list, as is typical and conventional in queue item related devices, only one item can be on the top of the queue. Any item below the top item might also be extremely important, but this information and the sense of urgency are lost for any item not on the top of the list. There is no system currently in existence that permits the simple configuration of fixed, escalating, prioritization tiers, and the application of those escalating prioritization tiers to queue items in run time. The present inventors have appreciated that what is missing in conventional queue techniques is a way to assign a common fixed prioritization code scheme to all queue items regardless of the relative sort position.

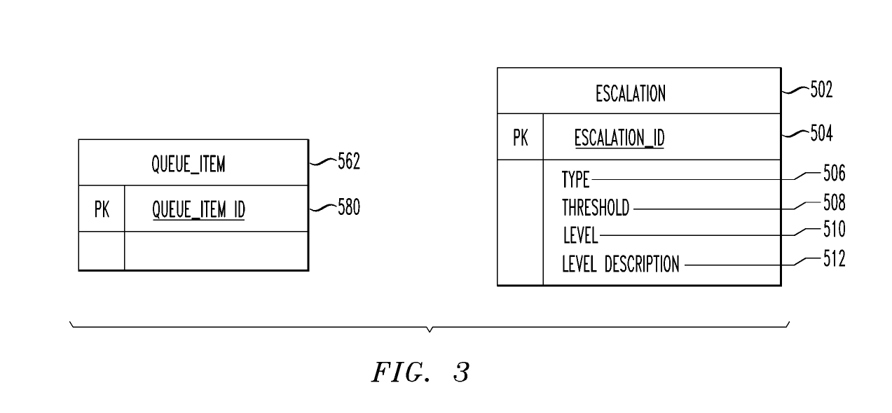

FIG. 3 shows an exemplary configurable escalation queue, in accordance with the principles of the present invention.

In particular, as shown in FIG. 3, the configurable escalation queue 562 may or may not be a rapid assignment dynamic ownership queue 262 as shown and described with reference to FIG. 2.

The geospatial emergency management (GEM) 9-1-1 system implements a configurable escalation queue (CEQ) 562 for management of incoming emergency text messages. The configurable escalation queue 562 assigns queue items 580 absolute, not just relative, escalation codes 504.

GEM911 is a public safety answering point (PSAP) operator web server application system for handling 911 related text messages sent from mobile devices. The implementation of the web application was achieved using specific software technologies, such as Ruby on Rails and SQLLite, but is not limited in implementation to any particular software technologies. The unique ideas, designs patterns, data models, and all other explained concepts, can be implemented in any software technologies to achieve an effective escalating priority system for queue items, in accordance with the principles of the present invention. Similarly, the content or purpose of any device using a configurable escalation queue (CEQ) 562 is not limited to 911 or Public Safety Answering Points. Any device that displays queue items will benefit from a configurable escalation queue (CEQ) 562, regardless of the nature or content of the queue items 580 and any special techniques or methods required to assign their prioritization.

The configurable escalation queue (CEQ) 562 is unique as it ranks all queue items 580 in absolute terms, but a relative queue-sorting method still takes place. In this way, a configurable escalation queue (CEQ) 562 enables sorting of queued items 580 according to the needs of their specific domain.

By using the configurable escalation queue (CEQ) 562, each item 580 in the configurable escalation queue (CEQ) 562, regardless of its position within the configurable escalation queue (CEQ) 562, be it first or last in the configurable escalation queue (CEQ) list, has an escalation code 504 associated therewith. This escalation code 504 can easily be used to alter the presentation of the queue items) 580 as needed to alert application users (e.g., PSAP operator terminals) of the priority level.

The configurable escalation queue (CEQ) 562 uses two database tables: A Queue_Item database table 562, and an Escalation database table 502. Any database technology can be used to create these database tables. The specific database table names in this document are generic for the purposes of this disclosure. Examples with specific database table names are presented herein, but these specific database table names may be any name.

The Queue_Item database table 562 can have any table name, and as many or as little fields as needed, to support the specific requirements to form a configurable escalation queue (CEQ) 562.

The second database table is the Escalation database table 502. The Escalation database table 502 may be implemented with as much flexibility as possible, including the table name itself and the field definition. The disclosed embodiments of an Escalation database table 502 must include four database fields associated with each escalation code 504: type 506, threshold 508, level 510, and level description 512.

type 506 is implemented in the disclosed embodiments as a text based field that is used as a filter to determine which kind of Queue_Items 580 the Escalation evaluations should be applied to.

threshold 508 is implemented in the disclosed embodiments as a numeric field that allows an application to compare, as in numeric greater than less than, against values, either stored or calculated, that come from the Queue_Item 580 being evaluated for prioritization.

level 510 is implemented in the disclosed embodiments as a numeric, integer field for the prioritization level. This is the end result of the escalation evaluation.

level_description 512 is implemented in the disclosed embodiments as a text-based field to specify in human readable words what the escalation level 510 means, its definition, its impact, etc.

Once correct content is loaded into the Escalation database table 502, a simple database query is performed against the Escalation table 502. The database query uses two input parameters: type 506 and threshold 508. The type parameter is used for character matching and is compared to the type field 506 of the Escalation records 504. The threshold parameter is used for numeric ‘greater than/less than’ comparison and is compared to the threshold field 508 of the Escalation records 504.

The type 506 and threshold 508 parameters going into the database query are supplied, by whatever means are best for the specific server, device or other application, from the target Queue_Item 580 or data related to the target Queue_Item 580 being evaluated.

The database query against the Escalation table 502 returns zero to many Escalation records 504. The Escalation record 504 with the highest level value is the escalation level of the target Queue_Item 580. The idea is that as threshold parameter 508 values increase or decrease, more and more Escalation records 504 return from the query, each additional Escalation record 504 adding a higher level 510 value than that of the previous database query. In the case that no Escalation records 504 are returned from the database query, the configurable escalation queue Queue_Item 562 is at the zero level, that is, no escalation, priority level.

In the specific disclosed embodiments using the disclosed GEM911 product, the Escalation table query evaluates each Queue_Item 580 based on a number of seconds since the last response. A different type 506, and therefore a different threshold 508, applies to text messages sent from mobile users to the PSAP and messages sent from the PSAP to mobile users. As the number of seconds since the last response increases, more and more Escalation records 504 return from the query, each with a higher value in the level field 510. This is only one example of how the configurable escalation queue (CEQ) 562 enables the assignment of escalating, absolute prioritization codes to queue items 580.

Because each Queue_Item 580 is assigned an absolute escalation level 510, graphical user interface (GUI) developers may use the level value 510 as a condition to alter the appearance of the Queue_Item 580. In the disclosed embodiments, a flag icon is added to the Queue_Item 580 once the queued item escalates from level 0 to level 1. Also, the Queue_Item 580 begins shakes at level 1. At level 2 the shaking increases in speed and amplitude. At level 3 the shaking increases further. Each and every queue item 580, regardless of queue position, has an escalation level 510 and the GUI can render that Queue_Item 580 in a way that best notifies the application user terminals or devices.

The disclosed configurable escalation queue (CEQ) 562 is highly generic and broadly applicable to any domain space and application content, thus benefiting all devices that use queued items.

### No Responders Online

The present inventors have appreciated that existing emergency responder systems typically lack flexibility as they are not dynamic because the scheduling and distribution arrangements between existing emergency systems are all made in advance.

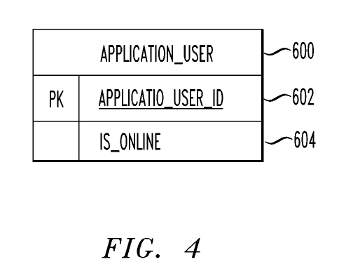

FIG. 4 shows a no responders online (NRO) Application_User table, in accordance with the principles of the present invention.

A No Responders Online (“NRO”) feature of the geospatial emergency management 9-1-1 system tracks and aggregates emergency responder activity across the system, which may be distributed, so that the system can be classified in the simple terms of “offline” or “online.” The “offline” response is especially important to emergency responder systems. Any request that comes to a system with no operators online must be sent back with a “we are all offline” answer as soon as possible. Without this safety net, emergency response systems would be unable to progress into geo spatial distribution.

For example, to pass any requests, such as text messages, between neighboring PSAPs, an emergency response system must be able to assess, across the network, the status of the neighboring PSAP system that would potentially take the request. Because the NRO in accordance with the principles of the present invention enables “offline” responses, which enables emergency response systems to make requests to each other, it can be used to significantly improve the flexibility of emergency response systems, such as PSAPs.

The no responders online (NRO) feature issues a short circuit “offline” response to any request made to the emergency system when no users are currently online. Similarly, the no responders online (NRO) attempts to acquire requests that the system was not able to receive while offline, when the first user logs into the system. In other words, when the emergency system goes from “offline” to “online”, it tries to play catch up.

The no responders online (NRO) enables individual emergency response systems to be more flexible. Remote responder activity is tracked the same as on site responder activity. The PSAP becomes distributed and still retains the dynamic online, offline answer modes. The use of no emergency responders online (NRO) also enables groups of emergency response systems to network on the fly.

There is no conventional system currently in existence that exhibits the dynamic, run time “online” and “offline” responses to emergency requests.

The present invention provides an emergency response system capable of dynamically issuing “online” and “offline” responses to emergency requests at run time, as driven by responder activity in an emergency system.

The no responders online (NRO) feature has been successfully implemented in the commercial product called GEM911, which is a PSAP operator web application for handling 911 related text messages sent from mobile devices. The implementation of this web application in an emergency network server environment was achieved using specific software technologies, such as Ruby on Rails and SQLLite, but is not limited in implementation to any technologies. The unique ideas, designs patterns, data models, and all other concepts explained in this document, can be implemented in any software technologies to achieve an effective offline response mechanism for emergency systems.

As implemented in the disclosed embodiments, the no responders online (NRO) emergency services feature uses a special field (e.g., a Boolean field) in the Application_User table as shown in FIG. 1. When an application user, such as a PSAP operator, logs into the system, the Boolean is set to true. When the user logs out, or is timed out by lack of activity or some other configurable means, the Boolean is set to false. Simply put, the application tracks when users enter and exit the system. It knows at all times if there is at least one emergency services responder terminal is online.

A simple database query can be used to determine the number of emergency services responder terminal devices currently online. Using this query, a preliminary check can be done against all incoming requests, to see if the “offline” short circuit response should be activated. Every API call visible to the outside world for incoming emergency requests performs this preliminary check before any other processing of the request is performed.

Similarly, when a responder logs into the emergency system, and that user is the first user to log on, the emergency system attempts to acquire requests that the system was not able to receive while offline. Every time a responder logs onto the system, the application checks if that user is the first, that is, if we are going from 0 to 1 currently logged in responders. If so, check if any active request on the network can be acquired and if so take them.

The present invention has particular applicability to emergency response, and emergency systems such as Public Safety Answering Point (PSAP) applications.

While the invention has been described with reference to the exemplary embodiments thereof, those skilled in the art will be able to make various modifications to the described embodiments of the invention without departing from the true spirit and scope of the invention.

What is claimed is:

1. Configurable escalation queue-sorting of a text message session, comprising:
queuing incoming text messages destined for a service bureau, at a network server;
assigning an escalation value to each incoming text message in an incoming text message queue, each escalation value having a type, a threshold, and a level associated therewith; and
occasionally resorting said queued incoming text messages both in order of a first in/first out queue and in order according to said escalation code assigned to each queued incoming text message.

2. The configurable escalation queue-sorting of a text message session according to claim 1, wherein:
said service bureau is an emergency services public safety answering point (PSAP).

3. The configurable escalation queue-sorting of a text message session according to claim 1, wherein:
said configurable escalation queue is comprised in an emergency services call server.

4. The configurable escalation queue-sorting of a text message according to claim 1, wherein:
a plurality of text messages from a common originating texting device are assigned together in a single text message session.

5. The configurable escalation queue-sorting of a text message according to claim 1, wherein:
said service bureau receives said queued incoming text messages via a text-to-teletype converter.

6. A configurable escalation queue queuing text message sessions with a service bureau, said configurable escalation queue comprising:
a queue item database table, each queued item in said queue item database table including an escalation code associated therewith; and
an escalation code database table;
wherein queued items in said queue item database table are occasionally resorted within said queued item database table based on an evaluation of said escalation code associated with each queued item.

7. A configurable escalation queue queuing text message sessions with a service bureau, said configurable escalation queue according to claim 6, wherein:
said queued items in said queue item database table are occasionally restored based on a type of queued item, and on a threshold of said queued item.

8. A configurable escalation queue for text message sessions, comprising:
means for queuing incoming text messages destined for a service bureau, at a network server;
means for assigning an escalation value to each incoming text message in an incoming text message queue, each escalation value having a type, a threshold, and a level associated therewith; and
means for occasionally resorting said queued incoming text messages both in order of a first in/first out queue and in order according to said escalation code assigned to each queued incoming text message.

9. The configurable escalation queue for text message sessions according to claim 8, wherein:
said service bureau is an emergency services public safety answering point (PSAP).

10. The configurable escalation queue for text message sessions according to claim 8, wherein:
said configurable escalation queue is comprised in an emergency services call server.

11. The configurable escalation queue for text message sessions according to claim 8, wherein:
a plurality of text messages from a common originating texting device are assigned together in a single text message session.

12. The configurable escalation queue for text message sessions according to claim 8, wherein:
said service bureau receives said queued incoming text messages via a text-to-teletype converter.
